(19) United States
(12) Patent Application Publication
(10) Pub. No.: US 2006/0156388 A1
(43) Pub. Date: Jul. 13, 2006

(54) Method and apparatus for a security framework that enables identity and access control services

(76) Inventors: Vlad Stirbu, Tampere (FI); Jose Costa-Requena, Helsinki (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/035,689

(22) Filed: Jan. 13, 2005

(51) Int. Cl. H04L 9/32

(52) U.S. Cl. 726/4

(57) ABSTRACT

A method by which access to services of a network are controlled, including a step in which a client device presents proof of identity to a service security module attached to the network and providing security against unauthorized access to the service.

### TECHNICAL FIELD

The present invention pertains to the field of networking electronic devices. More particularly, the present invention pertains to a security framework that enables a networking electronic device to activate security control when being accessed by another device.

### BACKGROUND OF THE INVENTION

Networking standards such as Universal Plug and Play (UPnP™) outline an architecture for connecting intelligent appliances, wireless devices, and personal computers. The UPnP standard is suited for networks in a home or a small business to provide a distributed, open networking architecture that leverages TCP/IP and Web technologies to enable seamless proximity networking in addition to control and data transfer among networked devices. With UPnP, a device can dynamically join a network, obtain an IP address, convey its capabilities, and learn about the presence and capabilities of other devices.

A UPnP network consists essentially of devices, services and control points. A device is a container of services, i.e. a device offers various services. For instance, a VCR device may offer a tape transport service, a tuner service, and a clock service. Each device includes or has associated with it a description, typically in the form of an XML (Extensible Markup Language) file. The device description indicates the different services offered by the device, and also properties of the device, i.e. e.g. the device name and icons representing the different services as well as other icons.

A service is said to be the smallest unit of control in a UPnP network, or in other words, a client can ask for a service, but cannot ask that the service be tailored in any way to a particular situation. A service executes actions and identifies its state by state variables. For instance, a clock service could be characterized as having a state variable called current_time for defining the state of the clock, and an action called set_time for setting the time, and so controlling the service. Like a device description, descriptions of the state variables of a service are maintained in an XML file, in what is called a service description, with different service descriptions typically kept in different XML files. The device description includes a URL (universal resource locator) for each service description serving as a pointer to the service description XML document.

A control point of a device is a functional entity used to discover and control other devices. A typical control point is a software module embedded in a controlling device, e.g. a personal computer. The control point of a device first discovers another device and then retrieves the device description and so obtains a list of associated services, retrieves the device description and then one or more service descriptions for services the device might want to request, perhaps requests a service, and if so then invokes actions to control the service and receives event information (state changes) from the host of the service, i.e. the other device. (The control point retrieves the device description (e.g. device type, manufacturer, etc) and after that the service description (e.g. clock service, etc.) available on that device.)

Devices on a UPnP network can be connected using any communications media including wireless or wireline radio frequency (RF), one or another kind of phone line, a power line, IrDA (Infrared Detection Association) media, any medium able to provide an Ethernet, and media according to IEEE 1394.

FIG. 1 illustrates steps of a prior art procedure by which a device joins a network of UPnP-enabled devices and obtains a service from one of the so-enabled devices. The foundation for UPnP networking is the TCP/IP protocol suite and the key to this suite is addressing. Thus, as shown in FIG. 1, the procedure includes an addressing step 11. For addressing, each device must include (i.e. host) a Dynamic Host Configuration Protocol (DHCP) client, and must search for a DHCP server when the device is first connected to the network. If a DHCP server is available, the device must use the IP address assigned to it. If no DHCP server is available, the device must use so-called Auto IP to get an address.

In a next step 12, discovery is performed, in which, once the joining device is attached to the network and addressed appropriately (i.e. once the device receives an address for use as a node of the network), the device advertises itself and its services to control points on the network, and, conversely, the joining device in turn searches the network for devices of interest (because of the services the devices offer). The fundamental exchange in both cases—the joining device discovering other devices and other devices discovering the joining device—is a discovery message containing a few essential specifics about the message-issuing device or one of its services, for example its type, its identifier, and a pointer to its device description document (typically an XML document/file).

In a next step 13, after a control point has discovered a device, it interacts with the device and retrieves the device description from the URL provided by the device in the discovery message. The UPnP description for a device—typically provided as an XML document—includes information such as model name and number, serial number, manufacturer name, URLs to vendor-specific Web sites, and so forth. The description also includes a list of any embedded devices or services, as well as URLs for control, receiving state change information (sometimes referred to as “eventing” to indicate signaling event information), and presentation.

In a next (control) step 14, after a control point has retrieved a description of the device so that the control point has the essentials for device control, to learn more about the service the control point retrieves a detailed UPnP description for each service. The description for a service is also (typically) expressed in XML and includes a list of the commands or actions the service responds to, and parameters or arguments for each action. The description for a service also includes a list of variables; these variables model the state of the service at run time, and are described in terms of their data type, range, and event characteristics.

To control a device, a control point sends an action request to a device's service. In response to the control message, the service returns action specific values or fault codes.

In a next (event publishing) step 15, the service publishes updates by sending event messages. Event messages contain the names of one of more state variables and the current value of those variables. A control point may subscribe to receive this information.

In a next (presentation) step 16, if a device has a URL for presentation, then the control point retrieves a page from the URL, loads the page into a browser, and depending on the capabilities of the page, allows a user to control the device and/or view the status of the device.

Security and access control for a UPnP network is enforced by what is called a Security Console, included in or serving as a control point. The Security Console provides the services necessary for authentication, authorization, replay prevention and privacy of UPnP actions. A device enforces its own access control but its access control policy is established and maintained by the Security Console. The Security Console is typically implemented so as to include a so-called DeviceSecurity module that implements access control for itself and for other Services in the same Device. There are two classes of access control: ownership and normal permission. Each security-aware device has an ownership list holding at least one entry. Any Security Console listed as an owner of a device has full rights to the device, specifically to all actions including the DeviceSecurity actions that specify other access control. In addition to the owner list, the device usually has an access control list (ACL) maintained by DeviceSecurity. Entries in the ACL for a device grant the Security Console or other Control Point permission to in turn grant to other devices access to sets of actions in respect to the device. The permission is for typically less than the full access associated with ownership. A Security Console might also be granted permission to delegate rights to others without having to be a full owner of the device or to define named groups of Control Points to be granted access as a group in a single operation.

The above-mentioned security features of the UPnP network may not be sufficient under some circumstances. For example, a network build of the user's own components with no connections to anything outside the user's personal domain and with no control points belonging to anyone other than the user ever attached to the network would not properly enact UPnP security features.

Thus, what is needed is a network security framework that is appropriate even in case of a network build of a user's own components with no connections to anything outside the user's personal domain and with no control points belonging to anyone other than the user ever attached to the network, and ideally, a network security framework that is easily scalable, is based on universal identity authentication protocol for access control, and supports multiple domains.

### DISCLOSURE OF INVENTION

Accordingly, in a first aspect of the invention, a method is provided comprising: a step in which a client device attached to a network obtains from a server device hosting a service and also attached to the network an indication of a security mechanism by which the server device limits access to the service; a step in which the client device obtains from an authenticator proof of identity; and a step in which the client device presents the proof of identity to a service security module attached to the network and providing security against unauthorized access to the service.

In accord with the first aspect of the invention, the method may further comprise a step in which the client device receives an indication of whether the server accepts the proof of identity, and the client device then accesses the service if the server accepts the proof of identity.

Also in accord with the first aspect of the invention, the service security module may be hosted by the server device.

Also in accord with the first aspect of the invention, the service security module may be hosted by a device different from the server device and may provide service security for not only the service of the server device but also for a service offered by another device attached to the network.

Also in accord with the first aspect of the invention, the authenticator may be a physical device located at an entry way to the network, and the client device may communicate with the authenticator using a near-field communication protocol or a touch-based communication protocol.

In a second aspect of the invention, a computer program product is provided comprising a computer readable storage structure embodying computer program code thereon for execution by a computer processor, wherein said computer program code comprises instructions for performing a method according to the first aspect of the invention.

In a third aspect of the invention, a device is provided, comprising: means for obtaining from a server device an indication of a security mechanism by which the server device limits access to a service; means for obtaining from an authenticator proof of identity of the device; and means for presenting the proof of identity to a service security module.

In accord with the third aspect of the invention, the device may also comprise means by which the device receives an indication of whether the server device accepts the proof of identity, and by which the device then accesses the service if the server device accepts the proof of identity.

In a fourth aspect of the invention, a network is provided, comprising a client device, a server device offering a service, and a service security module providing security against unauthorized access to the service and either integral with or separate from the server device, wherein the client device includes: means for obtaining from the server device an indication of a security mechanism by which the server device limits access to the service, means for obtaining from an authenticator proof of identity of the client device, and means for presenting the proof of identity to the service security module; and wherein the server device includes means for determining whether to accept the proof of identity and for granting access to the service if the server device accepts the proof of identity.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram of action steps taken by a device with control point while joining a network.

FIG. 2 is a block diagram of a local network, incorporating an authentication server/identity agent, according to the invention.

FIG. 3 is a block diagram/flow diagram of action steps taken by device with control point, with additional steps for authentication, according to the invention, while joining a network.

FIG. 4 is a block diagram showing signalling between elements of the invention.

FIG. 5 is a block diagram illustrating entities communicating according to the invention.

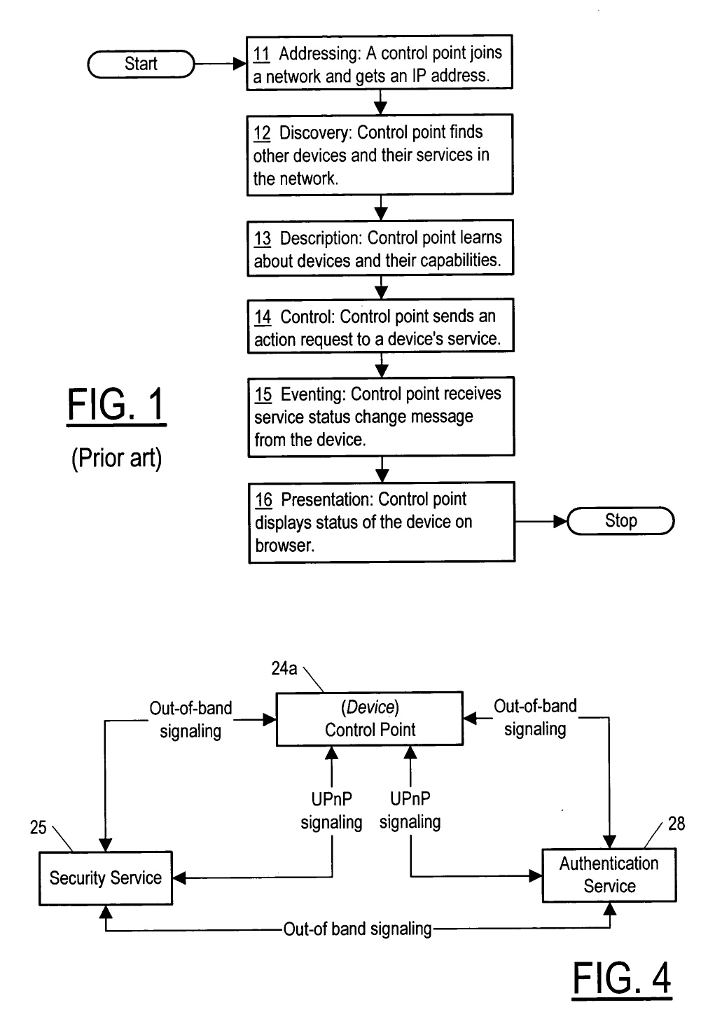

### BEST MODE FOR CARRYING OUT THE INVENTION

The invention is a system for controlling access by a first device over a network to services of a second device connected to the network. Either of the devices can be either operated by a user or programmed to operate autonomously. The network may or may not be connected to the Internet. A system according to the invention includes a control point in the first device, a service security module, which may be in the second device or may be hosted in a third device and may then provide network-wide service security, and an authenticator (in a third device) accessible to the control point. The control point is programmed not to access the service except via the steps of the invention, which, in effect, require that the control point provide to the service security module proof of its identity, and then wait for the service security module to provide access. The proof of identity comes from the authenticator (e.g. via a certificate or a ticket). The control point gets its proof of identity (really the proof of identity of the first device) from the authenticator (following a successful authentication that can be implemented using short range communications such as communications via NFC (near field communication) technology, Infrared technology, Bluetooth technology, and so on) and then presents it to the service security module, which checks that the so-identified first device/control point is authorized to access the requested service. (If the control point cannot provide proof of identity, the service security module may still provide access, e.g. treating the first device as anonymous or guest device.)

According to the invention, after the first device “discovers” the second device on the network and learns from a device description for the second device (included with or associated with the second device) that the second device offers a service the first device wants (e.g. the second device offers as a service to client devices a particular file for downloading by the client devices) the control point (in the first device) communicates with the service security module (of the second device) and determines what security mechanism, among possibly several different security mechanisms, the service security module is programmed to use. The control point then also locates an authenticator appropriate to the service the control point wants access to, and appropriate to the domain in which the second device (the device offering the service) is located. (The authenticator may be a local agent—part of the network including the first and second device—or proxy of an authentication service located elsewhere, and so e.g. accessible via the Internet.) The communication between the control point and the authenticator can be done using the UPnP network or using a secured but separate communication channel, such as an NFC channel, an Infrared channel, a Bluetooth channel, and so on. The control point then obtains proof of identity from the authenticator and presents it to the service security module. The service security module then verifies the proof (in a way that depends on the security mechanism being used) and grants access to the service if the service security module verifies the proof. (For example, the proof of identity could be a trust certificate issued by the authenticator including an encryption using a private key, and the service security mechanism could verify the trust certificate using the public key of the authenticator.)

The invention thus provides a generic security framework in which identity services and access control services are part of a local network, such as a UPnP network. With the invention, three entities—an authenticator, a service security module, and a control point—find and use a common security mechanism, and the communications channel for exchanging identity proof using UPnP network (e.g. offered as UPnP service) or a separated network (e.g. connecting through Internet) with a different bearer (e.g. connecting directly with the authenticator using a different bearer such as NFC, Bluetooth, Zigbee, Infrared, or other short range wireless radio technology). How a device not authorized to access a service becomes authorized to do so depends on the security mechanism, and is not the subject of the invention.

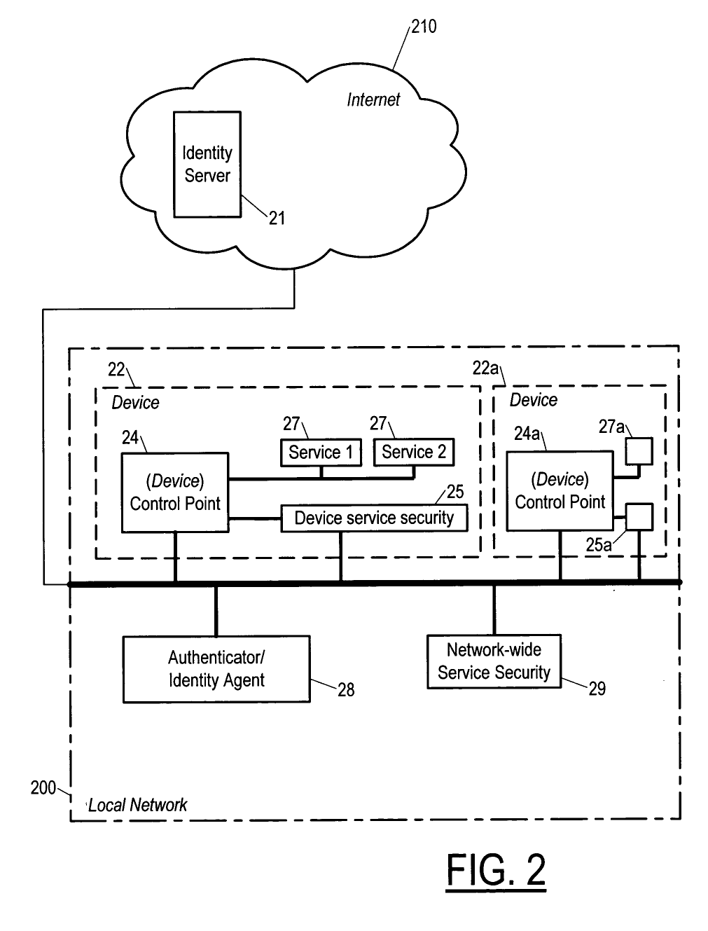

Taking a UPnP network as illustrative and referring now to FIG. 2, a minimal local UPnP network 200 according to the invention includes at least a device 22a having a control point 24a, another device 22 offering one or more services 27 and having a service security module 25 for protecting access to the services by other devices (via control points in the other devices) and also sometimes having a control point 24 for accessing services of other devices, and an authenticator 28 offering an authentication service or acting as an agent or proxy for an authentication service. Connection of the network 200 to the Internet 210 is optional.

The authenticator 28 offers as discoverable UPnP services an identity service, an authentication service, and optional access control services. Preferably, the authenticator is an agent of an Internet-wide identity service provider 21 such as Liberty Identity Provider, Radius Server, or a SIM (Subscriber Identity Module) server, and provides its services only for a particular domain (whereas a device will typically make its services available in more than one domain). The authenticator 28 maintains a device profile state variable for each device and a list of the security mechanisms supported by the devices, security mechanisms such as Liberty Identity Service, Web Services Security, and UPnP Security Console. The authenticator handles one security domain for each device, and stores the security domain for each device in a domain state variable of the device profile for the device. (Each user may have its own group of devices in the same network, hence creating its own domain. Moreover, each user may have different levels of security and can create a separate domain for each level of security, with different devices in each of the different domains, so that the user can create a guest domain having only a few devices all without sensitive data, for access by guest devices. Alternatively and preferably, each user may have a security domain that has several levels of trust; for example one for a guest account. Thus each domain is managed by a single domain authority—i.e. an authentication service—rather than having an authentication service for each level of trust.)

The Service Security module 25 of the device 22 provides authentication and access control as discoverable UPnP services. Thus, each device 22 is able to authenticate an entity attempting to access one or another of the services 27 the device offers, and prevent access if the device cannot authenticate the entity using the Service Security module 25.

In some embodiments, instead of there being a separate service security module for each device, there is—as illustrated in FIG. 2—a single network-wide service security module 29 for providing service security for all services offered by any device of the network.

The device control point 24 serves as an access point for services of the other devices protected by respective other service security modules. By various actions, in attempting to access a service of a device, the device control point checks what security mechanisms are supported by the device, finds out what authenticator to use depending on the domain of the device, and checks what security mechanisms are available. (A home network may contain several personal domains: a house will typically have a single network but each member of the family can have its own personal domain.)

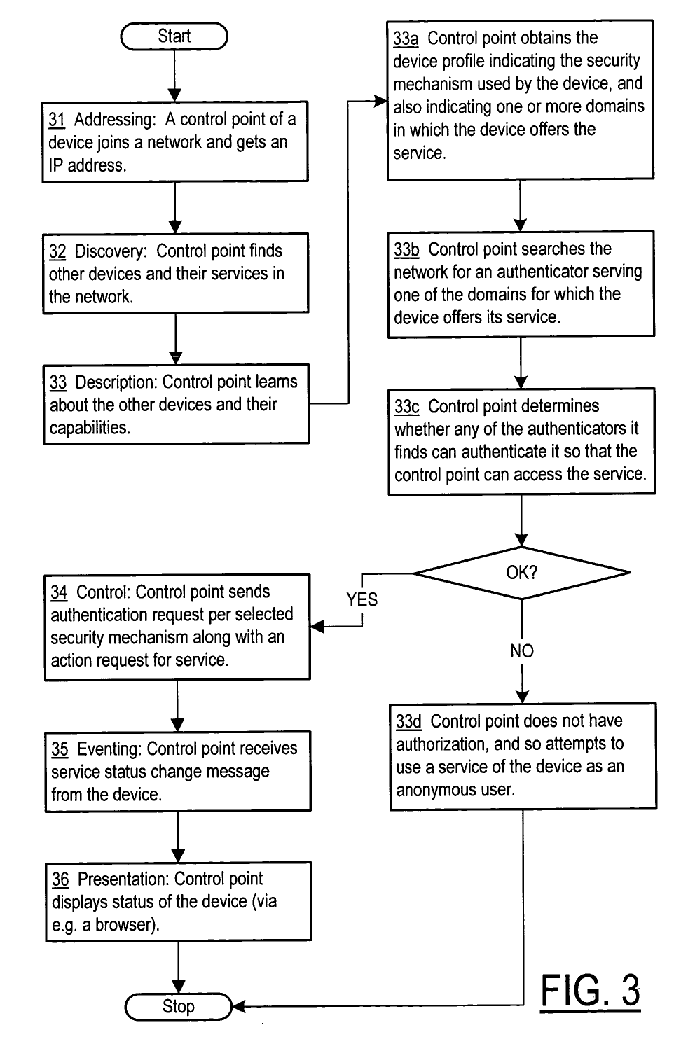

Referring now to FIG. 3 and also to FIG. 2, access to the services 27 of the device 22 by another device 22a, not at first connected to the local network 200, is shown as including a first (addressing) step 31 in which the device 22a joins the local network 200 and obtains an IP address for the device 22a all according to a prior art protocol. The device 22a is similar to the device 22 and so includes a control point 24a as well as other corresponding components: a security service 25a and (other, non-security) services 27a. In a next (discovery) step 32, the control point 24a finds other devices and their services in the network, including the device 22 and its services 27. In a next step 33, the control point obtains a description of the other devices and their capabilities/services. Assuming that the device 22 offers a service 27 the control point 24a wants access to (i.e. that e.g. the user of the device 22a wants to perform, a service such as “list all file names” in case of the device 22 hosting files), in a next step 33a, the control point 24a obtains the device profile indicating the security mechanism used by the device 22 (i.e. used by the service security module of the device 22), and also indicating one or more domains in which the device offers the service. In a next step 33b, the control point 24a searches the network for an authenticator serving one of the domains for which the device 22 offers its service. (The authenticator can be visible as a UPnP service, but the invention also encompasses the possibility that the authenticator communicates with the control point using a separate channel, outside the UPnP network, a channel such as a NFC channel or a channel for touch-based authentication, and so on.) In a next step 33c, the control point 24a determines whether the authenticators it finds can authenticate it so that the control point can access the service. If okay, i.e. if the authenticator can authenticate the control point, then, according to the invention, the control point has full access to the service (or services) of the device. In such a case, in a next (control) step 34, the control point sends an action request to a service of the device. In a next (eventing) step 35, the control point receives a service status change message (state change information) from the device being controlled. In a next (presentation) step 36, the control point 24a displays for a user the status of the device 22.

If the control point 24a cannot authenticate itself, it cannot gain authorization to use the services 27 of the device 22. It can then attempt to use the services as an anonymous user (and it is possible that an anonymous user is not allowed to used the services 27 of the device 22, and so service would then be denied).

Referring now to FIG. 4, signaling according to the invention is shown as including first in-band signaling (e.g. UPnP signaling or other TCP/IP signaling), i.e. signaling to agree on and set up a particular security mechanism (e.g. UPnP Security, WS Security, or Liberty Alliance), and then subsequent out-of-band signaling, i.e. signaling by which the services of a device are accessed via the security mechanism, i.e. using the security mechanism and so communicating using protocols dictated by the security mechanism. Thus, e.g., and again in case of a device 22a attempting to use the services 27 of the device 22, the control point 24a of the device 22a communicates via UPnP signaling (or other in-band signaling) with the service security module 25 of the device 22 to determine and set up (e.g. agree on encryption algorithms and keys) the security mechanism supported by the device (per the device profile), and does likewise with the authenticator 28. After the in-band signaling, the control point 24a does out-of-band signaling according to the invention to attempt to access a service 27 of the device 22, and the service security module 25 and authenticator 28 also communicate out-of-band.

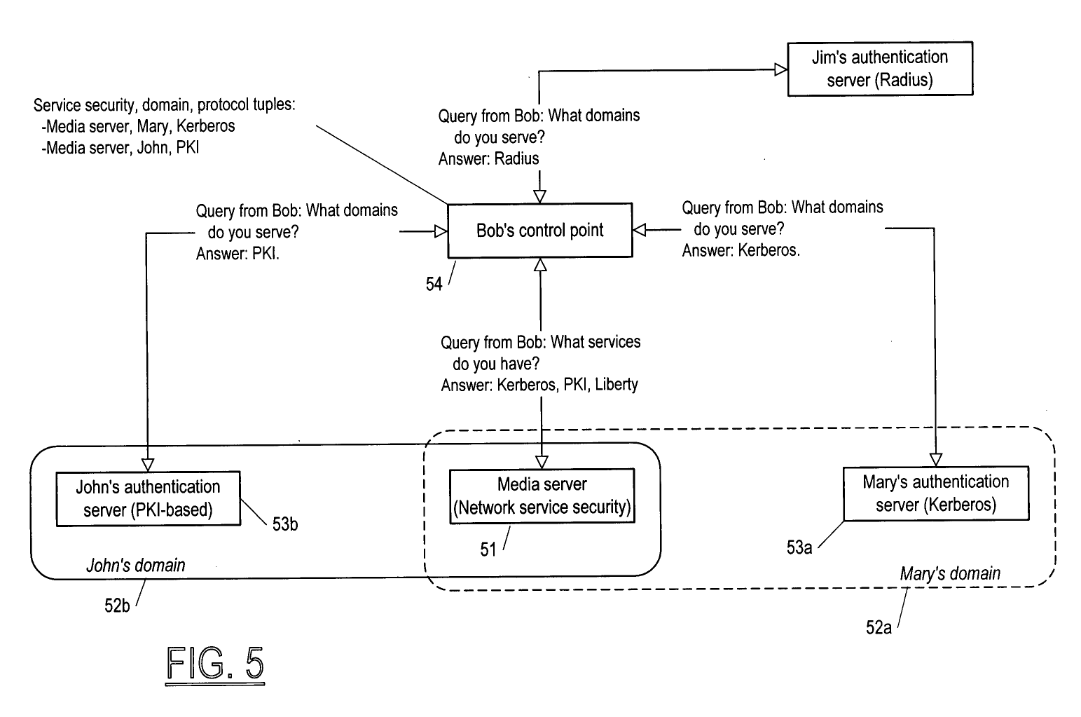

Referring now to FIG. 5, in an illustrative example of the invention, a media server 51 is used by two users, Mary and John, each having a respective domain 52a 52b forming part of a network. In order to restrict access to respective files Mary and John have stored on the media server, they each have an authentication server 53a 53b for managing access rights for their respective domains. The media server is a node of the network of Mary and John, and is configured so as to reside in both the domain of Mary and also that of John. The authentication servers are also nodes of the network, but reside in the respective domains of Mary and John. Bob is another user, not usually connected to the network of Mary and John.

When Bob comes to see John and Mary and wants to play some music, his control point 54 (hosted by a device operated by John) queries the media server 51 about the services available over the network and the security protocols supported by the media server. Then the device queries the authentication servers 53a 53b of Mary and John to determine which domains they serve. The authentication servers reply, indicating which domains they serve, and include in the replay the protocols they support. Bob's control point is then is able to build a list containing the tuple: Service security, Domain, Protocol. In this case the list is: Media server, Mary, Kerberos; and Media server, John, PKI. Then based on the list, Bob's control point can choose the best security mechanism to use. (Bob must use PKI to get to John's files, and must use Kerberos to get to Mary's, because there is only one choice for John and one for Mary. When there are multiple matches, the user can choose the best security mechanism according to other criteria, e.g. previous experience by the user.) The choice can be made autonomously by the control point, or under Bob's supervision. Bob's control point then uses the chosen security mechanism (in what is here called out-of-band signaling) for authenticating himself and gaining access to the files on the media server.

Notice that in the example of FIG. 5, the service security module 51 is a network-wide service security module, and so is not hosted by either a device residing exclusively in the domain of Mary or exclusively in the domain of John. Furthermore, the service (access to the files made accessible by Mary and john) is actually offered by the service security module 51 (i.e. the files are stored there), and not by a device residing exclusively in the domain of Mary or exclusively in the domain of John.

FIG. 5 also shows a server indicated as “Jim's authentication server.” This is illustrative of a case where the authentication service is outside the home network, a case also encompassed by the invention.

The invention is of use in case of any device able to support IP networking. The invention is especially of use in case of an isolated home network (and e.g. using UPnP for connecting a device to the network and allowing the device to use services offered by the other devices, of vice versa), since such an environment does not typically have a security infrastructure. As is clear from the above description though, the invention can be used even in case of a device in an environment/network having a security infrastructure, such as a device connected to the Internet by an ISP, or even e.g. a wireless communication device connected to an IP network (such as the Internet). Thus, e.g. the invention can be used in case of a cellular phone connected to e.g. the Internet via a radio access network.

Referring again to FIG. 2, the invention encompasses communications between the control point 24a and the authenticator 28 using a non-UPnP network or even a non-IP bearer, but using instead a short-range radio communications such as NFC, Bluetooth, Zigbee, and so on. Thus, the invention encompasses having a network-wide security service that takes care of the authentication procedure between an individual control point and each single device having its own security mechanism, in a way that is more or less transparent for a user. Thus, in one scenario the authenticator 28 can be discoverable as a UPnP service so that the control point 24a can provide its identity using the UPnP network. In another scenario, though, the authenticator 28 is a physical device located at the (physical) entry way to a network of devices. Thus, when a user (physically) visits the network, the user uses NFC or touch-based communications to send the user identity to the authenticator 28. Afterwards, there is no need for further exchange of credentials through the UPnP network.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
a step in which a client device attached to a network obtains from a server device hosting a service and also attached to the network an indication of a security mechanism by which the server device limits access to the service;
a step in which the client device obtains from an authenticator proof of identity; and
a step in which the client device presents the proof of identity to a service security module attached to the network and providing security against unauthorized access to the service.

2. A method as in claim 1, further comprising a step in which the client device receives an indication of whether the server accepts the proof of identity, and the client device then accesses the service if the server accepts the proof of identity.

3. A method as in claim 1, wherein the service security module is hosted by the server device.

4. A method as in claim 1, wherein the service security module is hosted by a device different from the server device and provides service security for not only the service of the server device but also for a service offered by another device attached to the network.

5. A method as in claim 1, wherein the authenticator is a physical device located at an entry way to the network, and the client device communicates with the authenticator using a near-field communication protocol or a touch-based communication protocol.

6. A computer program product comprising a computer readable storage structure embodying computer program code thereon for execution by a computer processor, wherein said computer program code comprises instructions for performing a method according to claim 1.

7. A device, comprising:
means for obtaining from a server device an indication of a security mechanism by which the server device limits access to a service;
means for obtaining from an authenticator proof of identity of the device; and
means for presenting the proof of identity to a service security module.

8. A device as in claim 7, further comprising means by which the device receives an indication of whether the server device accepts the proof of identity, and by which the device then accesses the service if the server device accepts the proof of identity.

9. A network, comprising a client device, a server device offering a service, and a service security module providing security against unauthorized access to the service and either integral with or separate from the server device, wherein the client device includes:
means for obtaining from the server device an indication of a security mechanism by which the server device limits access to the service,
means for obtaining from an authenticator proof of identity of the client device, and
means for presenting the proof of identity to the service security module;
and wherein the server device includes means for determining whether to accept the proof of identity and for granting access to the service if the server device accepts the proof of identity.
